(19) United States
(12) Patent Application Publication
(10) Pub. No.: US 2013/0171606 A1
(43) Pub. Date: Jul. 4, 2013

(54) SMART GRID EDUCATIONAL TOOL AND SYSTEM FOR USING THE SAME

(71) Applicant: Arthur Francis Seymour, Deerfield, IL (US)

(72) Inventor: Arthur Francis Seymour, Deerfield, IL (US)

(21) Appl. No.: 13/341,063

(22) Filed: Dec. 30, 2011

(51) Int. Cl. G09B 25/00

(52) U.S. Cl. 434/365

(57) ABSTRACT

A smart grid educational tool and system for using the same is provided. The smart grid relates generally to electro-mechanical systems with mechanical structures that produce electrical signals and switching systems similar to an actual smart power grid. This electrical system relates specifically to structures that easily and quickly demonstrate to students and utility workers the architecture and power sources used by the electric companies in the generation and distribution of electricity. The device utilizes an infrared beam of light sent through a spinning fan or other device, which breaks up the beam, to a receiving unit which produces an AC wave which is later converted to a single frequency sine wave and analyzed on a computer monitor.

### BACKGROUND OF THE INVENTION

A smart grid educational tool and system for using the same is provided. The smart grid relates generally to electro-mechanical systems with mechanical structures that produce electrical signals and switching systems similar to an actual smart power grid. This electrical system relates specifically to structures that easily and quickly demonstrate to students and utility workers the architecture and power sources used by the electric companies in the generation and distribution of electricity. The device utilizes an infrared beam of light sent through a spinning fan or other device, which breaks up the beam, to a receiving unit which produces an AC wave which is later converted to a single frequency sine wave and analyzed on a computer monitor.

Infrared (IR) light is electromagnetic radiation having a wavelength which is longer than that of visible light, measured from the nominal edge of visible red light at 0.74 micrometers (μm), and extending conventionally to 300 μm. These wavelengths correspond to a frequency range of approximately 1 to 400 THz and include most of the thermal radiation emitted by objects near room temperature. Microscopically, IR light is typically emitted or absorbed by molecules when they change their rotational-vibrational movements. Sunlight at zenith provides an irradiance of just over 1 kilowatt per square meter at sea level. Of this energy, 527 watts is infrared radiation, 445 watts is visible light, and 32 watts is ultraviolent radiation.

A light-emitting diode (LED) is a semiconductor light source. LEDs are used as indicator lamps in many devices and are increasingly used for other lighting. Introduced as a practical electronic component in 1962, early LEDs emitted low-intensity red light, but modern versions are available across the visible, ultraviolet and infrared wavelengths, with very high brightness.

When a light-emitting diode is forward biased (switched on), electrons are able to recombine with electron holes within the device, releasing energy in the form of photons. This effect is called electroluminescence and the color of the light (corresponding to the energy of the photon) is determined by the energy gap of the semiconductor. LEDs are often small in area (less than 1 mm²), and integrated optical components may be used to shape its radiation pattern. LEDs present many advantages over incandescent light sources including lower energy consumption, longer lifetime, improved robustness, smaller size, and faster switching. LEDs powerful enough for room lighting are relatively expensive and require more precise current and heat management than compact florescent lamp sources of comparable output.

Light-emitting diodes are used in applications as diverse as replacements for aviation lighting, automotive lighting (particularly brake lamps, turn signals and indicators) as well as in traffic signals. LEDs have allowed new text, video displays, and sensors to be developed, while their high switching rates are also useful in advanced communications technology. Infrared LEDs are also used in the remote control units of many commercial products including televisions, DVD players, and other domestic appliances.

The present smart grid power simulator and system for using the same allows for a safe and fun teaching device for students and industrial plant operators. The device may be used to train operators without the need to disrupt an actual working power grid system. The device utilizes light emitting diodes and an interrupted infrared light beam to accurately measure the energy generation and consumption of this simulated smart grid. The infrared LED creates a light beam which is broken up by a rotating fan or other device. The rotating device produces a AC wave at a controlled frequency, which is displayed on a computer monitor and used to provide power to the simulated end users.

There are teaching aids that use mechanical products such as windmills or hand cranks to make DC voltages that light lamps or power small DC motors. Many of these devices are then used to amuse a child or teach a simple mechanical or electronic principle. Some teaching aids currently being sold that emulate the complex interactions in the real world that are required to distribute electrical power on a smart power grid are very large and expensive. These expensive aids usually try to generate AC voltages using actual miniature AC generators that are powered by only one energy source. Diagrams and videos are available to explain power distribution in a virtual environment but these teaching aids lack the physical interaction with real components such as power stations, transformers, power lines, meters, houses, and smart grid software. To completely understand the complexity of AC power distribution a teaching aid is required that emulates the mixing of both clean and polluting energy sources. Both hardware and software along with virtual test equipment, allow the student to fully grasp smart power grid principles as they learn through measurements in the system and control of generation and distribution of the AC voltage.

Other attempts have been made to produce simulated power grids for teaching utility workers. For example, U.S. Pat. No. 4,613,952 to McClanahan discloses a simulator which can simulate a multi-stage industrial plant that is controllable by a digital control and digital programmer for affecting plant operation. The simulator has a plurality of indicators mounted on a console for producing indications in response to display signals applied to the indicators. Also, a plurality of manually operated controls are mounted on the console for allowing production of manual signals. The simulator also has a computer coupled to the indicators for providing to them their display signals. The computer is also coupled to the manually operable controls for receiving their manual signals. The computer can respond to the manual signals of predetermined ones of the manually operable controls to provide a programmed array of processed values sized to simulate parameters existing during operation of the industrial plant. Given ones of this array of values are applied to specified ones of the indicators for providing their indication. The computer can also respond to programmed ones of the array of values for modifying the array to an extent and in a manner determined by the programming Also employed is a digital programming panel constructed the same as the plant's digital programmer, for affecting the programming and altering the simulator operation.

Further, U.S. Pat. No. 4,464,120 to Jensen discloses a simulator and signal processing system for interactive simulation or signal processing of models of complex dynamic systems includes a range of basic hardware processor modules, each of which simulates or signal processes a system element corresponding e.g. to the symbols of System Dynamics. The hardware processor modules are placed in sockets arranged in regular rows and columns on an electronic planning board to form a flow diagram structure of the dynamic system to be simulated or signal processed. The electronic planning board comprises power lines for energizing the hardware processor modules and a high bandwidth local bus structure which transfer information signals between neighoring modules placed on the electronic planning board. The simulator and signal processing system permits a constant low simulation or signal processing time irrespective of the size or complexity of the model to be simulated or signal processed. The result of the simulation or signal processing is displayed on color monitors via the front-end system which performs as interface between the hardware processor modules on the electronic planning board and the monitors, or other peripherals.

These devices and patents fail to disclose a smart grid education tool and system for using the same which can easily, quickly and safely act as a teaching tool for students and utility workers to learn and test aspects of a real world power grid system. Further, these devices and patents fail to disclose a simulated smart grid system which has multiple sources of energy that are used to create one single frequency AC power signal used to demonstrate the workings of a power distribution system.

### SUMMARY OF THE INVENTION

A smart grid educational tool and system for using the same is provided. The smart grid relates generally to electro-mechanical systems with mechanical structures that produce electrical signals and switching systems similar to an actual smart power grid. This electrical system relates specifically to structures that easily and quickly demonstrate to students and utility workers the architecture and power sources used by the electric companies in the generation and distribution of electricity. The device utilizes an infrared beam of light sent through a spinning fan or other device, which breaks up the beam, to a receiving unit which produces an AC wave which is later converted to a single frequency sine wave and analyzed on a computer monitor.

A safe electro-mechanical system is provided which easily demonstrates the principles of power distribution in a smart grid using low AC voltages and miniature transformers that emulate the real world power systems. A computerized software system is also provided which demonstrates how to maximize the use of clean reusable energy at electrical power generation facilities in a smart grid. This simulated system also allows for mixing of different DC energy sources to produce a single frequency AC voltage scaled to represent actual voltages and frequencies. Distribution of this AC voltage over great distance is emulated. Software in the system allows the system hardware to make adjustments so as to keep amplitude and frequency levels accurate at distant loads which may be varied. Test points are included to allow for educational investigation.

The present device and system are especially suitable for giving an educator or student a device which not only closely emulates a real smart AC power grid, but which does so in a safe manner designed to protect the user from harm and allows for investigation of the scaled down power grid components. Different energy sources in this system are emulated by different DC voltage inputs that could be derived from solar, wind, water, or other clean and reusable sources.

Actual working scaled down models of some of these sources are included in the invention. In an embodiment, DC from a computer port may be used to represent polluting fuels. The sum of these DC currents created from these DC voltages may be used to produce an infrared beam that is connected to circuits producing an AC voltage proportional to the total energy input. A graph of polluting versus reusable energy consumption is displayed on a computer screen for educational purposes.

A power amplifier may then be used to produce the AC power required to drive the smart distribution grid. A transformer is used to step up the voltage that is transmitted over wires with resistance added to emulate a long distance. Another transformer is used to return the voltage to the required value for consumer consumption on the receiving end of the high voltage line. For safety purposes the actual voltages are reduced by approximately one hundred times. To reduce the size of transformers required the AC frequency is increased by approximately ten times. Miniature houses with internal loads are switched on and off to emulate the consumption of the AC power after transmission.

Software of the system emulates a display panel which would be similar to a real display present in the power plant generating the voltages being transmitted. On this panel, the actual waveform of AC voltages transmitted and received is displayed. The display multiplies the voltage by approximately one hundred to emulate real world conditions without really increasing the actual voltages being used. The frequency is also divided by approximately ten on these displays to emulate the actual power grid frequency in use. If the load voltage falls below a low line value the power station automatically increases the voltage being generated to satisfy the load conditions. This is accomplished by increasing the current through an infrared diode that is mixing the different energy sources. If the frequency deviates from the desired set value, the power station automatically makes an adjustment on the DC motor that is attached to the device that is breaking the infrared beam. By eliminating the use of disposable batteries, this invention also follows the principles required to reduce pollution.

An advantage of the present smart grid and system for using the same is that the smart grid provides a realistic simulator of a power grid from an original source (such as coal, solar, nuclear, natural gas) through to a final consumer.

Another advantage of the present smart grid and system for using the same is that the smart grid provides an economical way of teaching students and utility workers how a typical power system works.

Yet another advantage of the present smart grid and system for using the same is that the smart grid provides a safe way to test components of a power gird on a small scale.

Still another advantage of the present smart grid and method of using the same is that the smart grid provides a computer connection and software package to measure the consumption of AC energy by simulated residential or commercial locations.

And yet another advantage of the present smart grid and system for using the same is to provide a portable device which is easy for a student or utility worker to test and learn about power grid systems.

For a more complete understanding of the above listed features and advantages of the smart grid power simulator and method of using the same, reference should be made to the following detailed description of the preferred embodiments and to the accompanying drawings. Further, additional features and advantages of the invention are described in, and will be apparent from, the detailed description of the preferred embodiments and from the drawings.

### BRIEF DESCRIPTION OF FIGURES

The accompanying Figures illustrate the following:

FIG. 1 illustrates a perspective view of the smart grid power simulator wherein numerous electrical and non-electrical components are secured to the same.

FIG. 2 illustrates a view of a computer screen with display showing: voltage of a generator, voltage at load, frequency controls, a graph of reusable versus bio-fuels, sectors or homes using power from grid and the smart grid switching control.

FIG. 3 illustrates an embodiment of an electrical schematic of the wiring of the smart grid power simulator.

FIG. 4 illustrates a block diagram of the smart grid systems key functions and feedback controls.

FIG. 5 illustrates a graph of the electrical current through the infrared diode versus the voltage peak to peak at an input to the AC filter in the circuit shown in FIG. 3.

FIG. 6 illustrates a schematic of the flow of power through the system.

FIG. 7 illustrates a slotted infrared optical switch of the present system.

FIG. 8 illustrates a transformer of the device.

### DETAILED DESCRIPTION OF THE PREFERRED EMBODIMENT

A smart grid educational tool and system for using the same is provided. The smart grid relates generally to electro-mechanical systems with mechanical structures that produce electrical signals and switching systems similar to an actual smart power grid. This electrical system relates specifically to structures that easily and quickly demonstrate to students and utility workers the architecture and power sources used by the electric companies in the generation and distribution of electricity. The device utilizes an infrared beam of light sent through a spinning fan or other device, which breaks up the beam, to a receiving unit which produces an AC wave which may later be filtered to a sine wave of a single frequency and analyzed on a computer monitor.

In alternating currents (commonly referred to as “AC”) the movement of electric charge periodically reverses direction. Conversely, in direct current (“DC”) system, the electric charge flow only proceeds in one direction. Generally, homes and businesses receive electric power in the form of alternating current (AC). The usual waveform, of an AC power circuit, is a sine wave; although, different waveforms are sometimes used, such as square or triangular waves. Audio and radio signals carried on electrical wires are also examples of alternating current.

In 1850 Rudolf Clausius proposed the first law of thermodynamics which states that energy cannot be created or destroyed. Instead, “electricity generation” is merely the process of generating electric energy from other forms of energy. The fundamental principles of electricity generation were discovered during the 1820s and early 1830s by the British scientist Michael Faraday whose basic methods are still used in power grids today. More specifically, electricity is “generated” by the movement of a loop of wire, or disc of copper between the poles of a magnet.

The electric utilities are the first process in the delivery of electricity to consumers. After electricity is generated by the utilities, the electricity must still pass through the electricity transmission stage, distribution stage, and electrical power storage and recovery stages using pumped storage methods which are normally carried out by the electric power industry.

Electricity is most often generated at a power station by electromechanical generators, primarily driven by heat engines fueled by chemical combustion or nuclear fission but also by other means such as the kinetic energy of flowing water and wind. There are many other technologies that can be and are used to generate electricity such as solar photovoltaic and geothermal power. In the United States, the AC power is generated from coal, natural gas, nuclear, hydroelectric conversion, renewables and petroleum; in that order. Other countries, such as France, rely much more heavily on nuclear energy.

The present system may also utilize an optical coupler. In electronics, an opto-isolator, also called an optocoupler, photocoupler, or optical isolator, is “an electronic device designed to transfer electrical signals by utilizing light waves to provide coupling with electrical isolation between its input and output”. The main purpose of an opto-isolator is “to prevent high voltages or rapidly changing voltages on one side of the circuit from damaging components or distorting transmissions on the other side.”

An opto-isolator contains a source (emitter) of light, almost always an infrared light-emitting diode (LED), that converts electrical input signal into light, a closed optical channel (also called dielectrical channel), and a photosensor, which detects incoming light and either generates electric energy directly, or modulates electric current flowing from an external power supply.

The slotted optical switch, sometimes known as opto-switch or optical switch but not to be confused with the optical coupler, is a device comprising a photo-emitter such as an infrared LED and a photo-detector such as a photodiode mounted in a single package so that the photo-emitter normally illuminates the photo-detector, but an opaque object can be inserted in a slot between them so as to break the beam. Associated circuitry is provided which changes state when the beam is interrupted. For example, the carriage of a computer printer may be fitted with a projection which interrupts the beam of a slotted switch when it reaches the end of its travel, causing circuitry to react appropriately. Another application of the slotted switch is in the type of computer mouse with a rotating ball. The ball measures distances moved by rotating orthogonal shafts which drive chopper wheels turning in the slots of slotted switches.

The optical switch uses the same basic components as an opto-coupler, but is operated by manipulating the light path instead of the photo-emitter input. The present device 1 uses a slotted infrared optical switch to produce the AC frequency and the photo-emitter input to add the different energy sources.

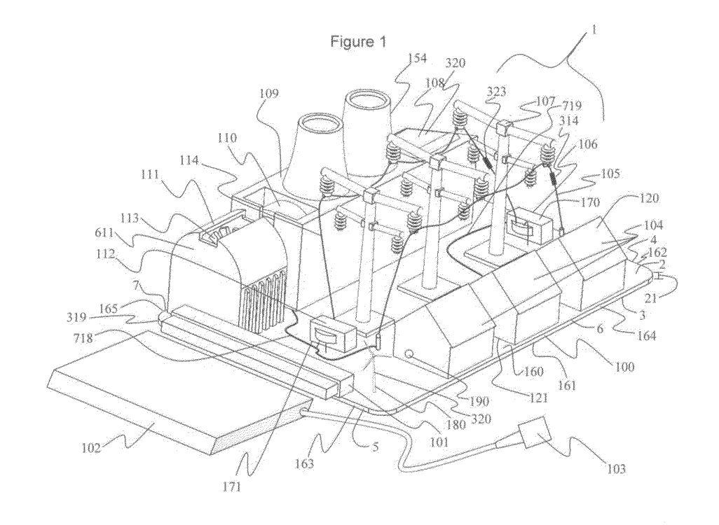

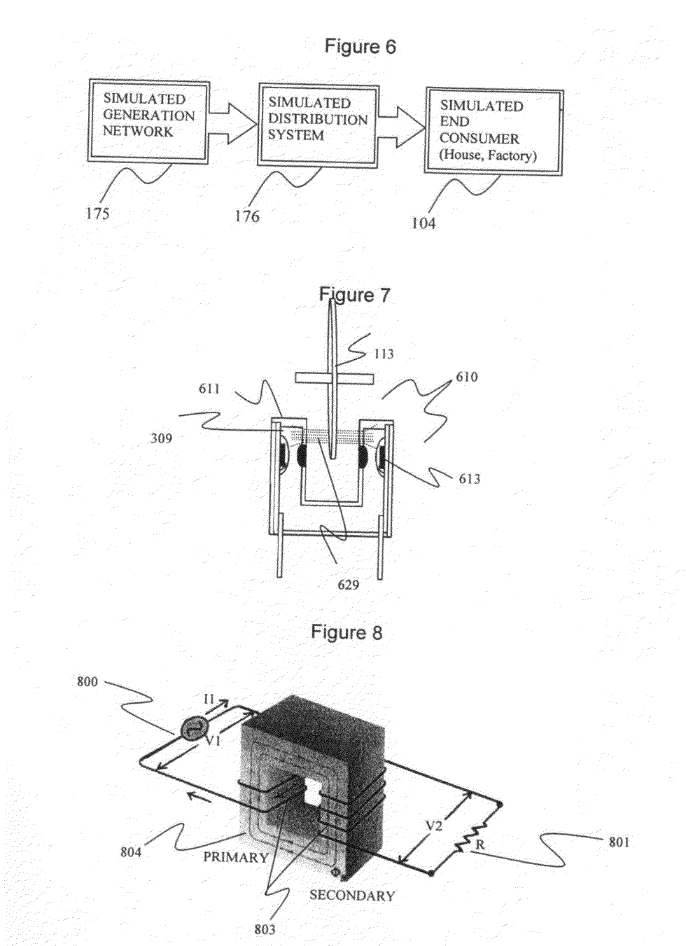

Referring now to FIG. 1, a smart grid power simulator 1 is provided. The smart grid power simulator 1 may have a simulated generation network 175 (FIG. 6) which “generates” the electricity, a simulated distribution system 176 which carries and delivers the electricity from the simulated generation network 175 to a simulated AC power consumption simulator device 104 (such as a home or office building). The simulated generation network 175, simulated distribution network 176 and simulated AC power consumption simulator devices 104 may all have physical elements in addition to the electrical components and electrical information that is transferred through the same.

The smart grid power simulator 1 may have a top 2, a bottom 3, a first side 4, a second side 5, a front 6 and a back 7. In an embodiment, the smart grid power simulator 1 may be generally the size of, for example, a small notebook computer. The smart grid power simulator 1 of the present application is generally illustrated in a rectangular manner in the drawings; however, the smart gird power simulator 1 may take any suitable shape.

The smart gird power simulator 1 may have a circuit board 100 forming a base portion. The circuit board 100 may have a top 160, a bottom 161, a first side 162, a second side 163, a front 164 and a back 165. The circuit board 100 of the present smart grid power simulator 1 may be largely planar and may have a height 21. Further, the circuit board 100 may be strong enough so as to support numerous components (as discussed below) which may be secured and/or may rest on the top 160 of the circuit board 100. More specifically, the circuit board 100 of the smart grid power simulator 1 may have electrically conductive and electrically non-conductive components.

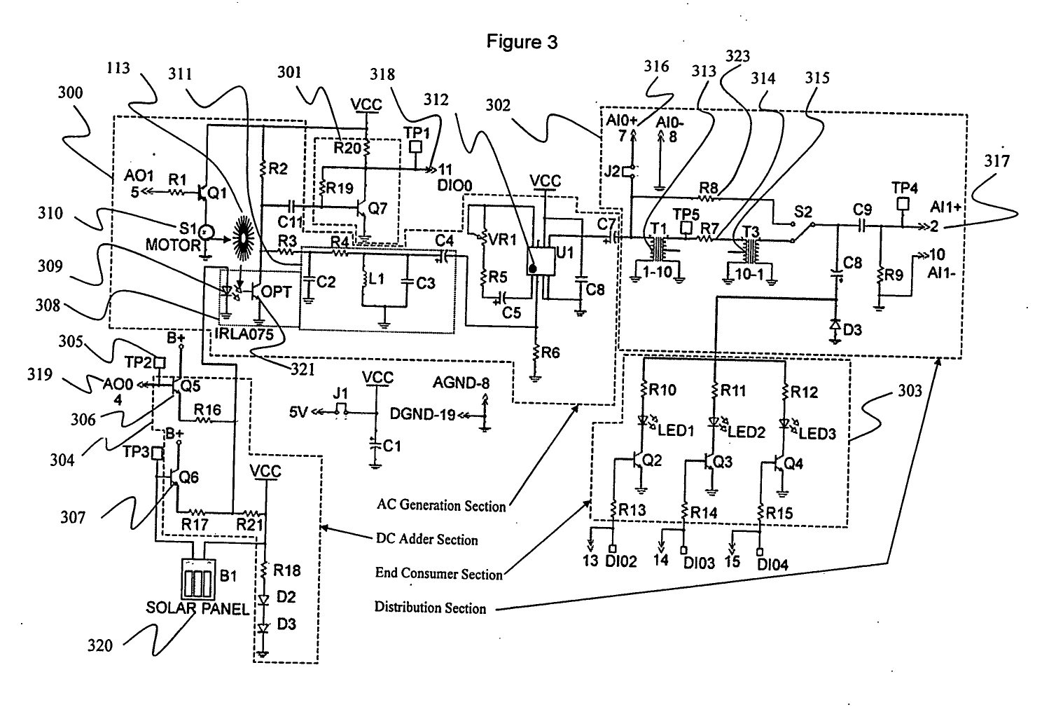

As part of the simulated distribution network system 176, the smart grid power simulator 1 may have a plurality of working simulated AC power distributors 106, 107, 112. More specifically, AC power distributor 106 of the simulated distribution network system 176 may physically resemble and perform similar tasks as, for example, a sub-station step down transformer of a real power system. AC power distributor 107 of the simulated distribution network system 176 may physically resemble and perform similar tasks as, for example, a power line pole 107 of a real power system. AC power distributor 112 of the simulated distribution network system 176 may physically resemble and perform similar tasks as, for example, a sub-station step up transformer of a real power system. The sub-station step up transformer 112 may transfer electricity from the simulated generation network 175 directly to the AC power consumption simulator devices 104 whereas the sub-station step down transformer 106 may transfer electricity from the simulated generation network 175 first to the power line poles 107 and then to the consumption simulator devices 104. The electrical circuitry of the simulated AC power distributors 106, 107, 112 is outlined in box 302 of FIG. 3.

The simulated overhead power line poles 107 of the present device 1 may have low voltage transmission lines 105 and high voltage transmission lines 114, both of which may be rubber coated for safety reasons. The figures illustrate three overhead power line poles 107 connected via transmission lines 105 or 114; however any number of overhead power line poles 107 and transmission lines 105 or 114 may be implemented. One of the power transmission lines 105 or 114 of the present system may electrically connect an overhead power line pole 107 to a simulated sub-station step down transformer 106. Further, a simulated sub-station step down transformer 106 may be electrically connected via a wire 719 to the AC power consumption simulator devices 104 (end consumer) of the system.

The AC power transformers 106, 112 may each have a top 170 and a bottom 171. The bottom 171 of the simulated AC power transformers 106, 112 may be secured to the top 160 of the circuit board 100 by, for example, screws or the like and may be interchangeable so as to allow the users to alter and test the overall system functions.

The AC power distributors 106, 107, 112 of the system may be the final stage in the delivery of the electricity to the AC power consumption simulator devices 104 (the end consumers); receiving the power from the generation network system 175. The simulated AC power consumption simulator devices 104 of the present system may be, for example, simulated residential buildings, commercial buildings or factories. The AC power consumption simulator devices 104 may have a top 120 and a bottom 121 wherein the bottom 121 may be electrically or non-electrically connected to the top 160 of the circuit board 100 of the device 1.

As stated above, the distribution system network 176 carries the electricity from the generation network system 175 and delivers it to the simulated AC power consumption simulator devices 104. Typically, a real-life electricity network would include medium-voltage (less than 50 kV) power lines, substations and pole-mounted transformers, low-voltage (less than 1 kV) distribution wiring and sometimes meters 190. In the present system, for safety and economic concerns, the electricity network of the present device 1 may have, for example a simulated medium-voltage (between 1,000 and 33,000 volt) power transmission lines 114, simulated sub-station step up 112 or step down 106 transformers, simulated overhead power line poles 107, simulated low-voltage (less than 1,000 volts) transmission lines 105 and simulated meters 190. The simulated components may be physical components of the system 1, but may perform largely identical functions as in an actual electricity network.

The present device and system 1 have portions which simulate AC power generators of a real power system. For example, the device 1 may have a simulated nuclear generator 154. In the present device, the simulated nuclear generator 154 may have two portions, a control portion 109 which monitors and controls both frequency and shape of the electrical signal and a generation portion 111 which creates the signal at the proper magnitude. Together the control portion 109 and the generation portion 111 form the standard AC nuclear power generator 154 which generates electricity. Box 300 of FIG. 3 illustrates the electrical circuitry of the simulated standard nuclear power generator 154 of the present system 1. In an embodiment, the system has DC power generators. More specifically, the system 1 may have, for example, a solar panel 108 generator or water or wind turbine generator 180.

The power generators 108, 180 of the present system may be electrically connected to the DC adder section 304 of the present system. In an embodiment, most of the power generators (such as the wind turbine 180 and solar panel 108) may actually function similar to their full scale versions. Further, in an embodiment, only the nuclear generator 154 may be asimulation and not a functional generator. In an embodiment, the standard control portion 109 adds DC from the solar panel 108 and/or DC from wind turbine 180 and emulated nuclear DC power to produce AC power. This AC may be electrically connected directly to the power line pole 107 via a connecting wire 718 (FIG. 1); therein skipping the step up transformer 112.

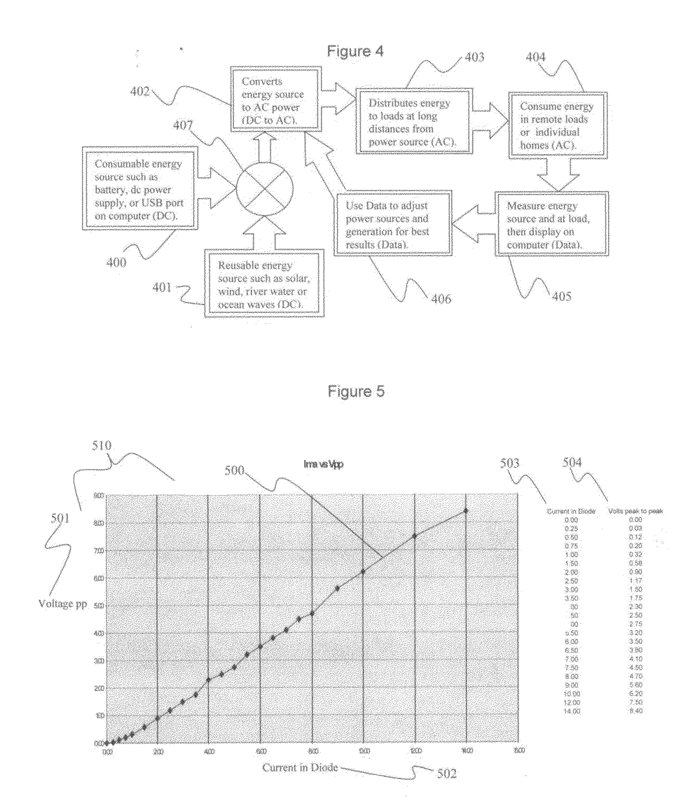

As stated above, the system may have AC power distributor simulators 106, 107, 112 and AC power consumption simulator devices 104. In an embodiment, the system may also have polluting and consumable energy source simulators 400 (FIG. 4) which may be represented by, for example, a DC input from an external source 319 (such as a battery, DC power supply or USB port on a computer) and which may be measured on TP2 305. The polluting and consumable energy source 400 DC current may be added to a reusable clean energy source 320 (such as solar) by a transistor Q5 306 in the DC current adding section 304 of the schematic diagram of FIG. 3. The polluting and consumable energy source 400 and reusable clean energy source 320 may each be electrically connected to each other via the circuit board 100.

As stated above, a reusable energy source 320, such as, for example, energy obtained from a solar panel 108 may be added to the circuit board 100 of the system. The reusable energy source 320 may generate electricity and add the same to the system 1. The solar panel 108 of the present system may be a fully functional solar panel and the wind turbine 180 may be a fully functional wind turbine. The energy created from the solar panel 108 may be used to produce a DC current which may run through a transistor Q6 307 in the DC current adding section 304 of the schematic diagram of FIG. 3. /

In an embodiment, a plurality of simulated reusable energy sources 320 may be used. For example, alternative to or in addition to the solar panel 108, reusable energy may be generated by, for example, a water or wind turbine 180 or the like. The sum of the electricity generated from all of the reusable energy sources 320 may be ultimately passed to an infrared diode 309 (as discussed below) located in an optical switch 610 (FIG. 7). The optical switch 610 circuitry may be located in the AC generation section 300 of the schematic diagram of FIG. 3. When the reusable energy sources 320 are added to the system, a change in electrical current 502, 503 in the infrared diode 309 of the optical switch 610 may produce a proportional change in the amplitude of the volts peak to peak 501, 504 from the optical switch 610. As stated above, the optical switch 610 may be a passive optical component that is capable of combining DC sources and producing an AC output at a controlled frequency.

Referring again to FIG. 7, the device 1 may have an optical switch 610 located within a housing 611. The optical switch 610 may have an infrared diode 309 (also called a photoemitter). The housing 611 of the optical switch 610 may be located on the top 160 of the circuit board 100. As light 629 exits the infrared diode 309 of the optical switch 610, the light 629 may pass through a spinning disc or rotating fan 113. The spinning disc or rotating fan 113 may be powered by a DC motor 110 (FIG. 1). The fan 113 may be located inside the housing 611 such that light 629 emitted from the infrared diode 309 may pass through the spinning fan 113 (or other device which breaks up the light beam).

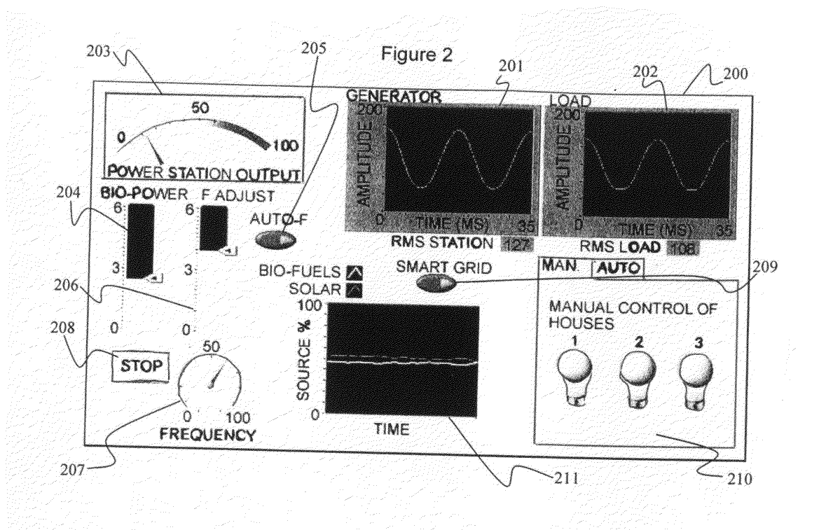

The light 629 that passes through the rotating fan 113 may be received by a photosensor 613 located on the opposite side of the fan 113 as the infrared diode 309. Preferably the rotating fan 113 may have blades which break up the light beam and allows from 0% to 100% of the light 629 to pass through depending on the position of the fan blade. Further, the fan 113 should rotate at a constant speed so as the light beam 629 passing through the fan 113 to the photosensor 613 consistent data may be recorded. As the spinning disc or rotating fan 113 modifies the light beam 629 of the device 1, an electrical signal of the optical switch 610 therein creates a sine wave. The sine wave data may be electrically communicated to a computer monitor 200 (FIG. 2) for analysis such as frequency, amplitude, and distortion.

The current in milliamps 502, 503 through infrared diode 309 to voltage peak to peak 501, 504 out of the optical switch 610 relationship is shown in FIG. 5. A stronger current 502, 503 will produce a brighter infrared output from the infrared diode 309. The spinning disc 113 driven by DC motor 110, 310 interrupts the infrared beam in the optical switch 610 and produces a sine wave output from an optical coupler transistor 321. This sine wave output is amplified and sent through a connector 101, 318 to an interface module 102, 405 and USB cable 103 to a computer screen 200 (FIG. 2) to be displayed on a frequency indicator 207. The output of the optical switch 610 is also passed through a band pass filter 311 tuned to reduce distortion and produce a single frequency sine wave output. Because the sine wave is produced after the currents from the DC sources are added 304, 407 and before AC voltage 501 is generated, there is no need to synchronize the phase of AC voltages before addition can be performed.

The sine wave is amplified by a power amplifier 312 and sent to a transformer T1 112, 313 in the power distribution section 176, 302, 403 to step up the filtered AC voltage 501 to a higher voltage. This higher voltage is transmitted through a high voltage transmission line 114 to a step down transformer T2 106, 315 for distribution to the remote loads (AC power consumption simulator devices) 104, 303, 404. Both the high voltage transmission line 114 and the low voltage transmission line (the straight through line) 105 may be supported by the high miniature power line poles 107 and brought to simulated end consumer (the loads) 104.

To emulate a long wire, resistors R7 314 and R8 323 may be placed in series within each of the respective transmission lines 114, 105. More specifically, R7 314 may be electrically connected to the high voltage transmission line 114 and R8 323 may be electrically connected to the low voltage transmission line 105. The voltage at the input to transformer T1 112, 313 is also sent through a connector 101, 316 to the interface module 102, 405 and USB cable 103 to a computer screen 200 (FIG. 2) to be displayed on a generator waveform graph 201. In a similar manner, the voltage at the load side of the high voltage transmission line 114 is sent through a connector 101, 317 to the interface module 102, 405 and USB cable 103 to a computer screen 200 to be displayed on a load waveform graph 202. These voltages are used to calculate the power being used by the simulated end consumers (homes) 104, 404 and also the power lost through the transmission lines 105, 114. This information may be then displayed on the computer screen 200 in the power station output meter 203. If the voltage at the simulated end consumer 104, 404 is below a predetermined value, a bio-power adjustment 204 is increased to supply more voltage coming from consumable source 400 and raises the current through the infrared diode 309 to increase the voltage coming from the generator 154, 402 until the load value 404 is satisfied.

A push button control of homes 210, 303 can change the loading on the generator 154, 402 manually or may be set to change automatically if desired. A stop button 208 on the computer screen 200 may stop the voltage output from the generator 154, 402 but may still allow the frequency controls 205-207 to function under no load conditions. When the Auto F control 205 is not active, the frequency can be changed by the F Adjust bar 206.

Referring now to FIG. 8, the transformers T1 112, 313 and T3 106, 315 of the device 1 may transfer electrical energy from a first circuit 800 to a second circuit 801 through inductively coupled conductors 803 called transformer coils. A varying current in the first or primary winding creates a varying magnetic flux in the transformer's core 804 and thus a varying magnetic field through the secondary winding. This varying magnetic field induces a varying electromotive force (EMF), or “voltage”, in the secondary winding. This effect is called mutual induction.

Although embodiments of the smart power grid educational tool and system for using the same are shown and described therein, it should be understood that various changes and modifications to the presently preferred embodiments will be apparent to those skilled in the art. Such changes and modifications may be made without departing from the spirit and scope of the device for increasing its educational value without diminishing its attendant advantages. It is, therefore, intended that such changes and modifications be covered by the appended claims.

I claim:

1. A miniature smart power grid for educational or training purposes comprising:
a base portion having a top and a bottom;
a plurality of power generation devices forming a power generation system wherein the plurality of power generation devices are connected to the top of the base portion and wherein the plurality of power generation devices generate electricity;
a plurality of power distribution devices forming a power distribution system wherein the plurality of power distribution devices are connected to the top of the base portion;
at least one power consumption device forming a power consumption system wherein the power consumption device is connected to the top of the base portion;
a first electrical wire electrically connecting the power generation system to the power distribution system;
a second electrical wire electrically connecting the power distribution system to the power consumption system;
a DC motor driven by one or more DC sources wherein the DC motor is included in the power generation system wherein the DC motor is used to interrupt an optical infrared beam in an optical slotted switch and wherein the slotted switch generates an AC electric voltage which is filtered through an electronic filter to produce a single frequency sine wave and wherein the sine wave is passed through the first electrical wire to the power distribution system and wherein the AC electricity generated by the DC motor, slotted switch, and electronic filter of the power generation system is converted to a higher voltage and passed through to the power distribution system; and
a computer monitor electrically connected to the smart power grid wherein the computer monitor displays the sine wave data.)

2. The miniature smart power grid of claim 1 wherein the infrared optical beam is modified by a spinning opaque fan blade to generate the sine wave.)

3. The miniature smart power grid of claim 2 wherein the generated AC wave is converted to a single frequency sine wave by an electronic filter output.)

4. The miniature smart power grid of claim 3 further comprising:
an amplifier electrically connected to the electronic filter output wherein an amplifier adjusts the AC voltage to a standard consumer AC values divided by 100.)

5. The miniature smart power grid of claim 1 further comprising;
a step up transformer electrically located between the power generation system and the power distribution system wherein the step up transformer increases voltage by a factor of 10.)

6. The miniature smart power grid of claim 1 wherein said electronic filter is designed to convert the output from said optical switch to a single frequency sine wave.)

7. The miniature smart power grid of claim 1 wherein the power consumption system has components representing miniaturized versions of houses, buildings and factories which consume energy and wherein the energy consumption is turned on or off to vary the load.)

8. The miniature smart power grid of claim 1 further comprising:
an interface module electronically connected to a computer containing software that represents and displays voltages in the same manner as an actual AC power generating stations.)

9. The miniature smart power grid of claim 8 wherein said voltages displayed on computer are multiplied by a factor greater than 25 to keep actual voltages low but have said voltage emulate the values in the real world power station when displayed.)

10. The miniature smart power grid of claim 1 wherein the power generation system, power distribution system and power consumption system have electronic components including: capacitors, resistors, diodes, light emitting diodes LED, display panels, inductors, transistors, semiconductors, power supplies, motors, fans, electronic sound emitters, speakers, buzzers, bells, alarms, microphones, light bulbs, strobe lights, switches, integrated circuits, computer chip, amplifiers, modulators, solar panels, computer interfaces, telephone interfaces, and combinations thereof.)

11. The miniature smart power grid of claim 1 wherein the AC voltage is used to generate an AC frequency which is greater than 60 therein reducing the size of the electrical components required to transform and transmit the voltage.)

12. The miniature smart power grid of claim 11 wherein said AC frequency is divided by a fixed number in order to display a frequency similar to consumer values.)

13. The miniature smart power grid of claim 11 wherein said AC frequency is automatically maintained at a fixed frequency.)

14. The miniature smart power grid of claim 11 wherein said AC frequency is controlled by an external computer.)

15. The miniature smart power grid of claim 1 further comprising:
a solar panel incorporated into the power generation system wherein the solar panel is used to generate DC power wherein the DC power generated by the solar panel is added to the power generation system of the existing system.)

16. The miniature smart power grid of claim 1 further comprising:
a wind turbine incorporated into the power generation system wherein the wind turbine is used to generate DC power wherein the DC power generated by the wind turbine is added to the power generation system of the existing system.)

17. The miniature smart power grid of claim 1 further comprising:
a computer having a software program wherein the computer is electronically connected to the smart power grid and wherein the software allows the user to control parameters of the miniature smart power grid by adjusting hardware modules in the miniature smart power grid.)

18. The miniature smart power grid of claim 1 further comprising:
at least one resistor electronically connected to the first or second electrical wire wherein the resistor reduces the power flow at a rate designed to simulate power lost in a real smart power grid as a result of the distance between the power generation system and the power consumption system.)

19. The miniature smart power grid of claim 1 further comprising;
a step down transformer electrically located between the step up transformer and the power consumption system wherein the step down transformer decreases voltage by 10 times.
